(19) United States
(12) Patent Application Publication
(10) Pub. No.: US 2008/0289004 A1
(43) Pub. Date: Nov. 20, 2008

(54) Method and Module for Protecting Against Attacks in a High-Speed Network

(75) Inventors: Christian Hauser, Moessingen (DE); Sebastian Kiesel, Stuttgart (DE); Marco Kraemer, Stuttgart (DE); Christoph Raisch, Gerlingen (DE)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 11/569,814

(22) PCT Filed: Apr. 7, 2005
(86) PCT No.: PCT/EP2005/051546

§ 371 Date: Aug. 10, 2007

(30) Foreign Application Priority Data
Jun. 4, 2004 (EP) 04102532.1

(51) Int. Cl. H04L 29/06; G06F 21/20

(52) U.S. Cl. 726/3

(57) ABSTRACT

A method, module and computer program for protecting a target against attacks in a high-speed network. The method according to the invention comprises the steps of generating a question, after having received a request from an initiator identified by a sourceID associated to a certain node in the network, sending the question to the node identified by the sourceID, in case that an answer to the question is received, evaluating the answer, and in case that a proper answer has been received, enabling communication between the initiator and the target by sending a further message from the target to the initiator.

### FIELD OF THE INVENTION

The present invention relates to the field of protecting against attacks in a high-speed network and more particularly, to a method and a module for protecting a target in a high-speed network against attacks. The invention further relates to a computer program product with a computer-readable medium and a computer program stored on the computer-readable medium with program coding means which are suitable for carrying out such a method when the computer is run on a computer. Moreover, the invention relates to a method for handling requests in a high-speed network.

### DESCRIPTION OF THE RELATED ART

In high-speed networks data exchange is performed based on standarized protocols like TCP/IP or InfiniBand. Communication between nodes in such networks is initiated by so-called handshake protocols which ensure a correct data transfer between the involved network nodes. In this way, certain nodes in a network the so-called initiators are enabled to use services provided by other nodes, hereinafter denoted as targets. Therefore, the initiator sends a request to a target offering a service required by the initiator.

Attacks in networks such as denial of service attacks are characterized by an explicit attempt by attackers to prevent legitimate users of a service from using that service. This can be archieved by using a false address or sourceID, respectively and flooding a target in the network by sending a lot of requests which need resources, thereby preventing the server from doing meaningful work.

Denial-of-service attacks can result in significant loss of time and money for many organizations using the network.

A known method uses a 4-way handshake protocol including an initiating message containing certain parameters, a first question message, a answer to the question containing the said parameters and a final message. However, this solution does not effectively prevent a flooding attack for protocols that rely on a predefined sequence of handshake messages.

### SUMMARY OF THE INVENTION

It is an object of the invention to provide a method and a module for protecting targets against attacks in high-speed networks which overcome the disadvantages known in the prior art. More particularly, it is an object of the invention to provide a method for handling requests in a high-speed network protecting targets in the network against attacks and consequently, ensuring a unrestricted availability of all services in that network.

These objects are achieved by proposing a method for protecting against attacks in a high-speed network with the features of claim 1, a module for protecting against attacks in a high-speed network with the features of claim 9 and a method for handling requests in a high-speed network according to claim 16.

According to the present invention, a method for protecting a target against attacks in a high-speed network is proposed, said method comprises the steps of generating a question, after having received a request from an initiator identified by a sourceID associated to a certain node in the network, sending the question to the node identified by the sourceID, subsequently, in case that an answer to the question is received, evaluating the question, and in case that a proper answer has been received, enabling communication between the initiator and the target by sending a further message, e.g. a ready to receive message, from the target to the initiator.

With this invention it is possible to prevent an denial-of-service attack in a network caused by a multitude of requests sent to a target from an initiator using a false sourceID.

According to a preferred embodiment, the method according to the invention is embedded in a 3-way handshake protocol.

Advantageously, the steps of generating the question and evaluating the answer are performed in a separate module. This separate module can be incorporated into a hardware module, such as a logic chip, PLD or FPGA, resulting in high processing speed.

Preferably, the question sent to the initiator comprises parameters associated with the sourceID and the target. This question can be encrypted in order to further increase reliability of the method according to the invention.

According to a preferred embodiment, the method according to the invention further comprises the step of entering initiator related information in a table. Therefore, it is possible to observe the number of connections between a certain initiator and a target or alternatively, the number of requests. As soon as the observed number of connections or requests exceeds a predetermined value, no more connections are established to prevent flooding of the target by the certain initiator.

Advantageously, the network is an InfiniBand network offering high speed and great performance.

Furthermore, the invention covers a module for protecting a target against attacks in a high-speed network comprising means for generating a question triggered by a request and means for evaluating an answer to this question.

Preferably, this module is incorporated into a hardware module, such as a logic chip, PLD or FPGA. This hardware module can be integrated into a network adapter housing or alternatively, into a separate housing.

According to another embodiment, the module is incorporated into a software module preferably, running on a separate processor.

The invention also covers a computer program product with a computer-readable medium and a computer program stored on said computer-readable medium with program coding means which are suitable for carrying out a method according to the invention when said computer program is run on a computer.

Moreover, the invention covers a method for handling a request in a high-speed network at a target using a common handshake protocol, wherein as soon as the load of the target caused by processing of requests exceeds a predetermined threshold value, the common handshake protocol is amended by a method according to any one of claims 1 to 8.

As the protection against request flooding is only needed in high utilization times, the common handshake protocol, typically an 3-way handshake protocol, can be used in low utilization times. The handshake protocol according to the invention introduces two additional steps and is used in high utilization times.

Further features and embodiments of the invention will become apparent from the description and the accompanying drawings.

It will be understood that the features mentioned above and those described hereinafter can be used not only in the combination specified but also in other combinations or on their own, without departing from the scope of the present invention.

The invention is schematically illustrated in the drawings by way of example and is hereinafter explained in detail with reference to the drawings. It is understood that the description is in no way limiting on the scope of the invention and is merely an illustration of preferred embodiments of the present invention.

### BRIEF DESCRIPTION OF THE DRAWINGS

Other aspects and advantages of the invention will become apparent upon review of the detailed description and upon reference of the drawings in which:

FIG. 1 shows a possible scenario for a denial of service attack,

FIG. 2 shows a diagram explaining a 3-way handshake protocol,

FIG. 3 shows a diagram explaining a 4-way handshake protocol in a TCP network,

FIG. 4 shows a diagram explaining the 4-way handshake protocol in an InfiniBand network,

FIG. 5 shows a diagram illustrating the 5-way handshake protocol in an InfiniBand network according to the present invention,

FIG. 6 is a block diagram schematically showing a module according to the invention in a network environment,

FIG. 7 shows a diagram explaining handling of a request in a network according to the invention and contains naming for FIG. 8, and

FIG. 8 is a flow chart illustrating the method according to the present invention.

### DESCRIPTION OF THE PREFERRED EMBODIMENTS

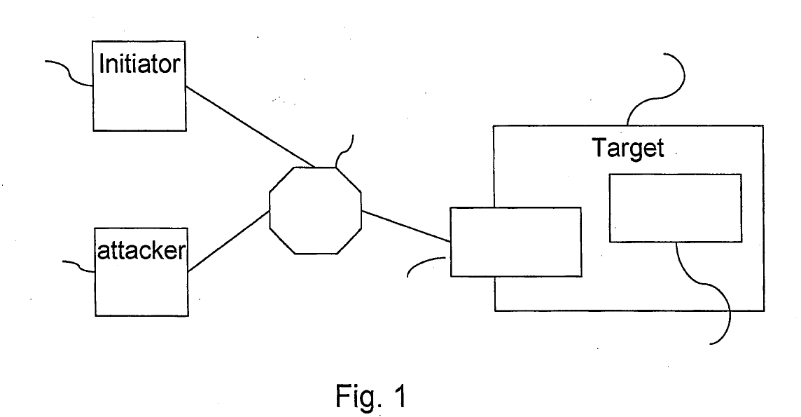

A possible scenario for a denial-of-service attack is shown in FIG. 1. An attacker 10 using the sourceID of an authorized initiator 12 sends an request to a target 14 via a fabric 16. According to the invention, this request is evaluated in a hardware networking module 18 to make sure that the resources of main CPUs 20 in the target are not consumed and flooding of the target is prevented.

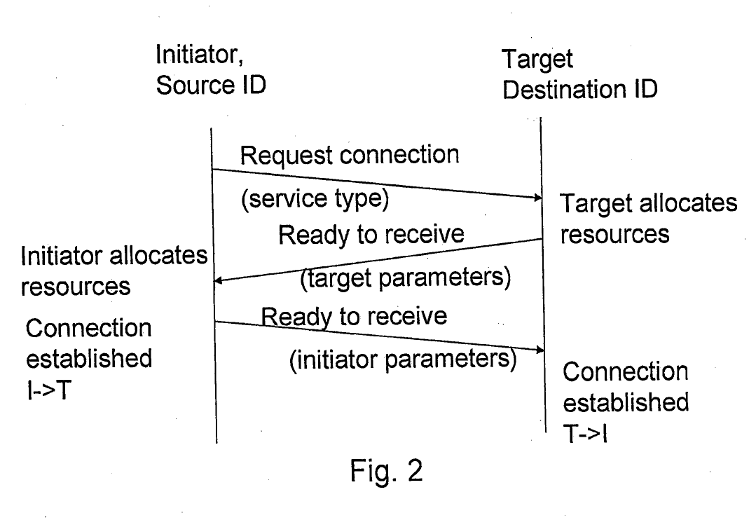

Referring to FIG. 2, a 3-way handshake protocol is illustrated. An initiator defined by a sourceID sends a request message to a target identified by a destinationID. The target sends back a ready to receive message including target parameters. To establish the connection the initiator transmits a ready to receive message containing initiator parameters.

Using the 3-way handshake protocol an attacker utilizing a counterfeit address can flood the target with connection requests, since the target allocates resources before identification of the initiator is performed.

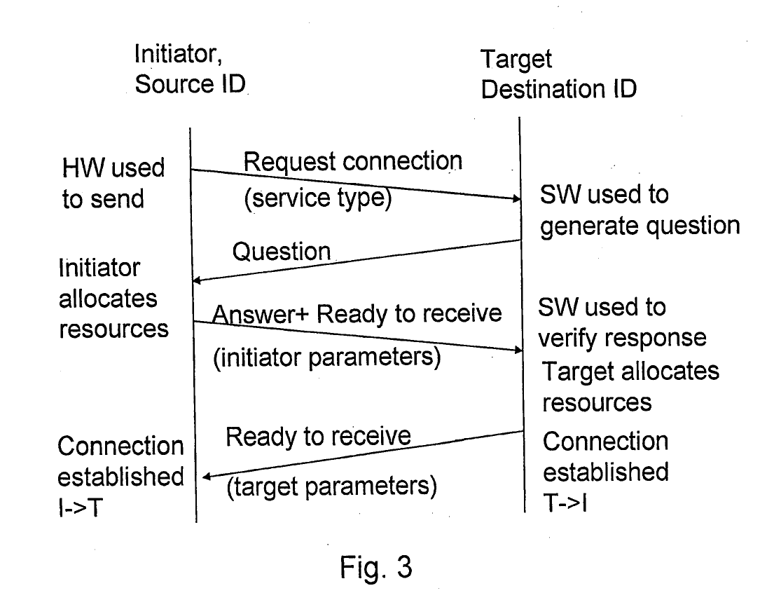

Referring to FIG. 3, a 4-way handshake protocol in a TCP network is shown. After having received a request from a initiator the target sends a question to the initiator which allocates resources. The initiator transmits an answer to the question together with a ready to receive message including initiator parameters. The target evaluates the answer and in case that it is a valid answer, sends back a ready to receive message to establish the connection. Consequently, the resource allocation is performed after identification of the initiator.

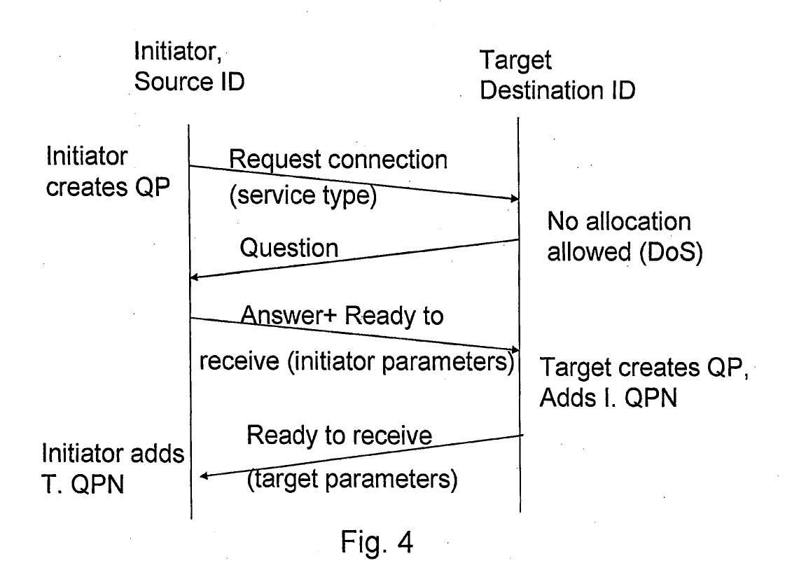

However, as illustrated in FIG. 4, the 4-way handshake protocol does not solve the request flooding attack problem in an InfiniBand network, since a non-transparent sequence change of I->T and T->I is caused, that is not transparent to upper layer protocols. As the I->T and T messages contain upper layer connection establishment parameters and QPNs, this approach is not feasible for an InfiniBand network. The problem is, that the target does not know when sending is allowed. Furthermore, this approach does not solve the problem in connection with the limited number of possible queue pair numbers.

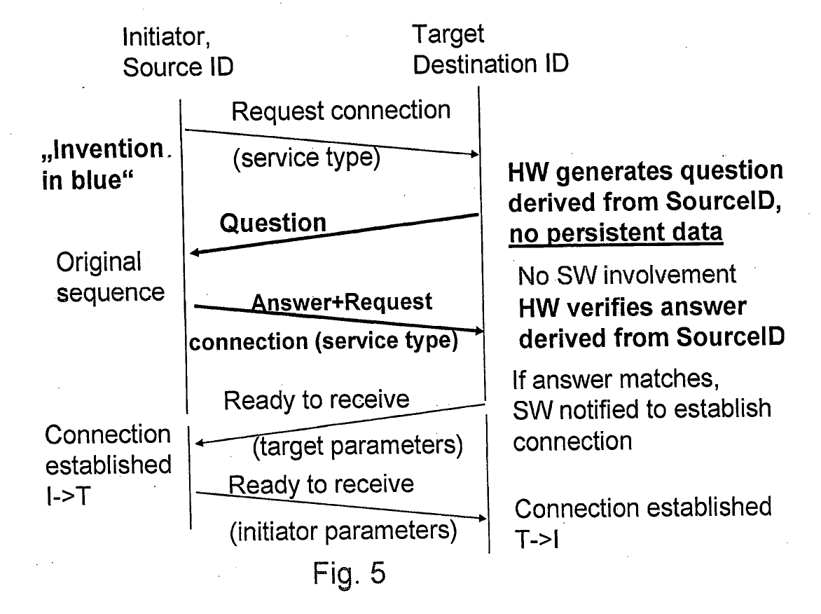

Referring to FIG. 5, a 5-way handshake protocol according to the invention is embedded in a 3-way handshake protocol. After having received a request from an initiator identified by a sourceID a target preferably, a hardware module associated with the target generates a question derived from the sourceID which does not include persistent data to the node identified by the sourceID. Consequently, an attacker using a counterfeit address does not receive this question and therefore, cannot answer the question. In case that a valid sourceID was used, the target answers the question. This answer is evaluated by the target. If the answer matches, the connection is established.

The question generation and answer check is performed without involving the software of the target. No persistent data must be stored in the target between the question and the answer. Moreover, the approach is transparent for upper level protocols and backward compatible in normal situations.

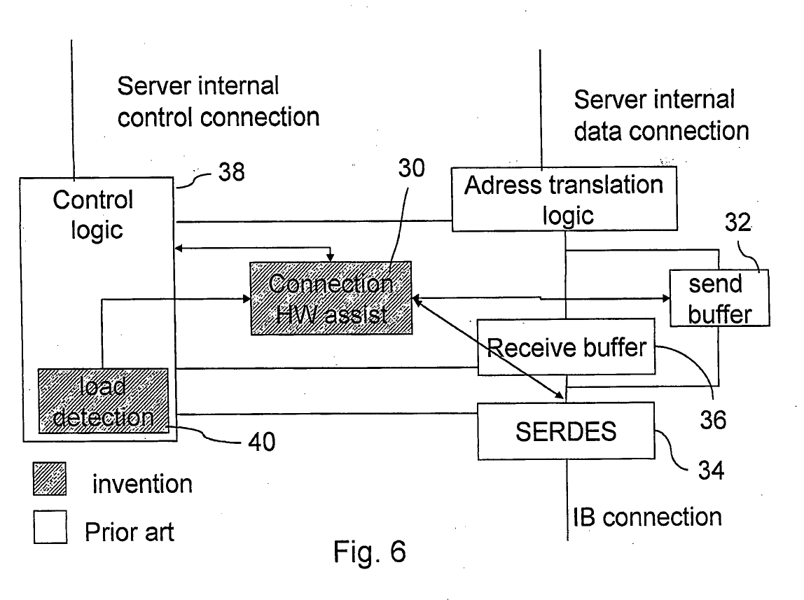

According to FIG. 6, a connection HW assist module 30 is connected to a send buffer 32 which contains the outgoing messages before they are transmitted. A SERDES 34 reads all incoming messages which are stored in a receive buffer 36. The module 30 is connected to a control logic 38 to trigger “Forward message” and “drop message” operations and to signal “additional high load information”, e.g. arrival of a connection request with source address or the arrival rate. A load detection module 40 containing a table comprising initiator related data signals “normal operation”, high load” and “drop all connection requests from a verified initiator” to the connection HW assist module.

The proposed 5-way handshake protocol is an effective solution for preventing flooding of a target. As the protection against request flooding is only needed in high utilization times, the 3-way handshake may be used in low utilization times. The 5-way handshake introduces two additional messages, the question or challenge, respectively and the challenge response.

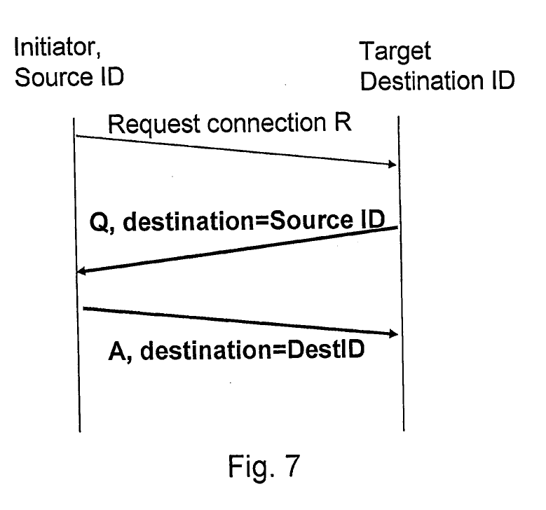

Referring to FIG. 7, an initiator using a sourceID sends a request R to a target for establishing a connection. The target generates a questions Q=f( . . . ) which is transmitted to the entity identified by the sourceID contained in R via a switch network. Only an entity receiving Q is able to create an answer A which is sent back to the target. The switch network transports A to the target based on the destinationID contained in Q. The target validates, if the creator of A has seen Q by g(A, . . . ). In a preferred embodiment Q=f(sourceID, key, . . . ) and valid=g(A, sourceID, key, . . . ).

Results of f should be hard to predict by any initiator without knowing “key” (plaintext cipher attack, freely chooseable plaintext), e.g. use of a regularly changed key. The key generation must not be predictable by any initiator, e.g. use of physical noise to generate key. Furthermore, different initiators must lead to different keys, e.g. by use of InfiniBand LID, GID, GUID as input parameters. The target decides based on A and “key”, whether the answer A has been sent by the initiator the address of which matches Q.

In an alternate implementation, the question message could be an InfiniBand redirection message (GetResp(ClassPortInfo)) containing InfiniBand parameters to be used for the answer. The answer is a repeated connection establishment message (InfiniBand REQ) with the original set of parameters except from the parameters specified in the question message (GetResp(ClassPortInfo) All parameters capable for redirection can be used to form the question message.

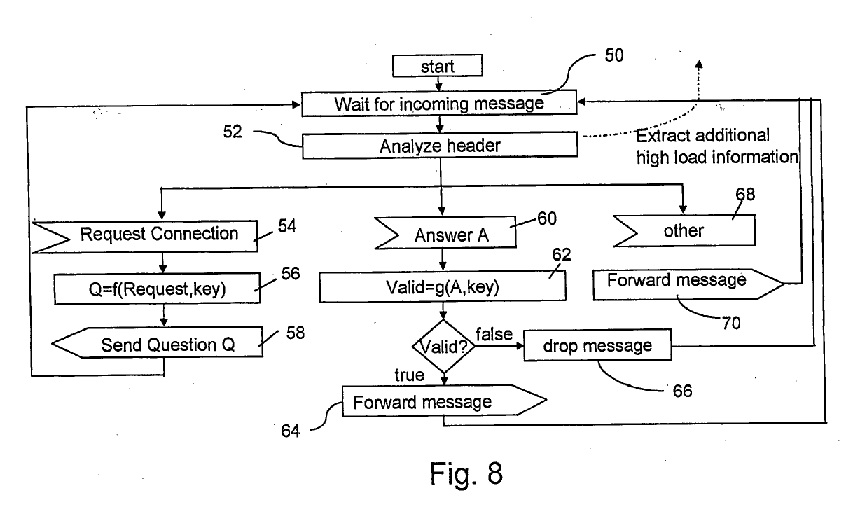

Referring to FIG. 8, a module associated with a target to be protected waits for an incoming message (step 50). Having received a message, the header of said message is analysed in step 52. If the received message is a request for a connection 54, a question is generated in step 56 and sent to the node identified by the received sourceID (step 58).

If the received message is an answer 60, this answer is evaluated in step 62. In case that the answer is valid, the message is forwarded to the target (step 64). If not, the message is dropped (step 66).

If the received message is neither a request nor an answer 68, the message is forwarded to the target (70).

1. A method for protecting a target against attacks in a high-speed network comprising the steps of:
generating a question, after having received a request from an initiator identified by a source ID associated to a certain node in the network;
sending the question to the node identified by the source ID;
in case that an answer to the question is received, evaluating the answer; and
in case that a proper answer has been received, enabling communication between the initiator and the target by sending a further message from the target to the initiator.

2. A method according to claim 1, wherein said method is embedded in a 3-way handshake protocol.

3. A method according to claim 2, wherein the steps of generating the question and evaluating the answer are performed in a separate module.

4. A method according to claim 3, wherein the separate module is incorporated into a hardware module.

5. A method according to claim 1, wherein the question comprises parameters associated with the source ID and the target.

6. A method according to claim 1, further comprising the step of encrypting the question.

7. A method according to claim 1, further comprising the step of entering initiator related information in a table.

8. A method according to claim 1, wherein the network is an InfiniBand network.

9. A module for protecting a target against attacks in a high-speed network, the module configured for generating a question triggered by a request and configured for evaluating an answer to the question.

10. A module according to claim 9 incorporated into a hardware module.

11. A module according to claim 10, wherein said module is integrated into a network adapter housing.

12. A module according to claim 10, wherein said module is integrated into a separate housing.

13. A module according to claim 9 incorporated into a software module.

14. A computer program product with a computer-readable medium and a computer program stored on said computer-readable medium with program coding means which are suitable for carrying out a method according to claim 1 when said computer program is run on a computer.

15. A computer program with program coding means which are suitable for carrying out a method according to claim 1 when said computer program is run on a computer.

16. (canceled)
